(19) United States
(12) Patent Application Publication
(10) Pub. No.: US 2026/0052329 A1
(43) Pub. Date: Feb. 19, 2026

(54) AUTOMATIC TOPOLOGY DISCOVERY FOR OPTICAL CROSS CONNECT

(71) Applicant: Cisco Technology, Inc., San Jose, CA (US)

(72) Inventors: Christian SCHMUTZER, Koenigsbrunn Im Weinviertel (AT); Luca DELLA CHIESA, Concorezzo (IT); Roberto MANZOTTI, Vaprio D'adda (IT)

(21) Appl. No.: 18/806,537

(22) Filed: Aug. 15, 2024

(51) Int. Cl. H04Q 11/00

(52) U.S. Cl. CPC H04Q 11/0062; H04Q 11/0005; H04Q 2011/0039; H04Q 2011/0058; H04Q 2011/0086; H04Q 2011/0088; H04Q 2011/009

(57) ABSTRACT

The present disclosure describes a computer system for discovering the topology of an optical cross connect. The computer system includes one or more memories and one or more processors communicatively coupled to the one or more memories. The one or more memories store a data structure indicating a state of a connection between a first optical port of a first optical fabric and a second optical port of a second optical fabric. A combination of the one or more processors determines that a source optical signal communicated to the first optical port is received at the second optical port over the connection and updates the data structure such that the state indicates that the connection is valid.

### TECHNICAL FIELD

Embodiments presented in this disclosure generally relate to optical communications. More specifically, embodiments disclosed herein relate to automatic topology discovery for optical cross connect.

### BACKGROUND

As the number of host devices in datacenters increases, so does the need for increased network capacity to interconnect the host devices. For example, datacenters that support artificial intelligence (AI) and machine learning (ML) applications may need to interconnect tens of thousands of graphics processing units. Due to cost and power consumption concerns, datacenters have been transitioning to using optical switches to optically interconnect the host devices. The optical switches provide low insertion loss, which allows the optical switches to be connected to form large, multi-stage switching fabrics (which may also be referred to as optical cross connects). The sheer size of these fabrics, however, makes it challenging to determine which switches are connected to each other and whether the connections are correct or intended. As a result, when a connection error occurs in the fabric, it is difficult to determine the cause of the error and to correct the error.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example computer system in the system of FIG. 1A.

FIG. 1C illustrates an example optical switch in the system of FIG. 1A.

FIG. 2 illustrates an example data structure in the system of FIG. 1A.

FIG. 3 illustrates an example operation performed by the system of FIG. 1A.

FIG. 4 illustrates an example operation performed by the system of FIG. 1A.

FIG. 5 illustrates an example operation performed by the system of FIG. 1A.

FIG. 6 illustrates an example operation performed by the system of FIG. 1A.

FIG. 7 illustrates an example operation performed by the system of FIG. 1A.

FIG. 8 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a system for discovering the topology of an optical cross connect. According to an embodiment, a computer system includes one or more memories and one or more processors communicatively coupled to the one or more memories. The one or more memories store a data structure indicating a state of a connection between a first optical port of a first optical fabric and a second optical port of a second optical fabric. A combination of the one or more processors determines that a source optical signal communicated to the first optical port is received at the second optical port over the connection and updates the data structure such that the state indicates that the connection is valid.

According to another embodiment, a method includes storing a data structure indicating a state of a connection between a first optical port of a first optical fabric and a second optical port of a second optical fabric, determining that a source optical signal communicated to the first optical port is received at the second optical port over the connection, and updating the data structure such that the state indicates that the connection is valid.

According to another embodiment, a non-transitory computer readable medium stores instructions that, when executed by a combination of one or more processors, cause the combination of one or more processors to store a data structure indicating a state of a connection between a first optical port of a first optical fabric and a second optical port of a second optical fabric, determine that a source optical signal communicated to the first optical port is received at the second optical port over the connection, and update the data structure such that the state indicates that the connection is valid.

### Example Embodiments

The present disclosure describes a computer system that discovers the topology of an optical cross connect. For example, the computer system may inject optical test signals into the optical cross connect and detect how the test signal travels through the optical cross connect. The computer system may detect whether the test signal was communicated to the correct ports in the optical cross connect to validate the connections in the optical cross connect.

The computer system uses a data structure to track the states of optical connections in the optical cross connect. The computer system updates the data structure when the computer system validates a connection or when the computer system detects an error in a connection. The data structure thus reflects the state of the interconnects in the optical cross connect. When connection errors are corrected (e.g., by replacing optical fibers or re-connecting optical fibers), the computer system detects the correction and updates the data structure accordingly.

In certain embodiments, the computer system provides several technical advantages. For example, the computer system detects connection errors in large optical cross connects that would otherwise go uncorrected. As a result, the computer system provides for correct communications through the optical cross connect. As another example, the computer system identifies individual connections (e.g., port-to-port connections) in the optical cross connect that are experiencing connection error, which allows these connection errors to be easily addressed or corrected.

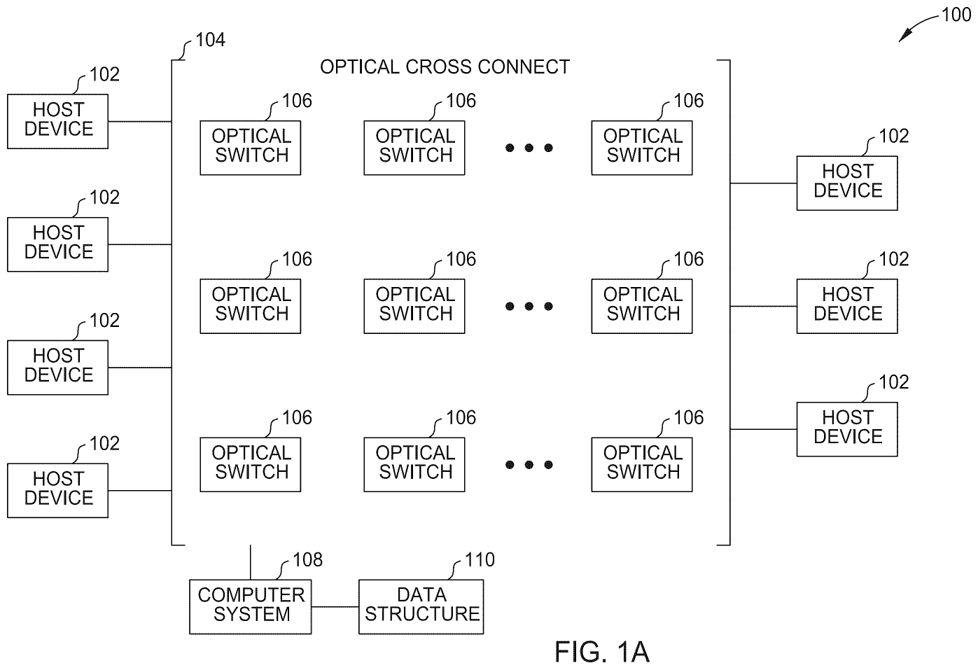

FIG. 1A illustrates an example system 100, which may be a datacenter that houses devices and networks. As seen in FIG. 1A, the system 100 includes multiple host devices 102, an optical cross connect 104, and a computer system 108. Generally, the optical cross connect 104 communicates optical signals between the host devices 102. The computer system 108 detects connection errors in the optical cross connect 104.

The host devices 102 may be computer systems (e.g., servers) or other devices that communicate with each other (e.g., graphics processing units for AI/ML applications). The host devices 102 are housed in the system 100 and communicate with each other through the optical cross connect 104. For example, each host device 102 may communicate optical signals to other host devices 102 through the optical cross connect 104. These optical signals may be modulated with data to carry the data between the host devices 102 through the optical cross connect 104.

The optical cross connect 104 includes a network of optical switches 106 that may be optically connected to each other and to the host devices 102 to form an optical communication network between the host devices 102. Each optical switch 106 may include multiple optical ports through which optical signals may be communicated. Optical fibers or cables may connect to the optical ports to carry optical signals between the optical switches 106 and between the host devices 102 and the optical switches 106. For the host devices 102 to communicate optical signals correctly between each other, the optical fibers or cables connecting the optical switches 106 have to connect to the proper or correct ports on the optical switches 106. If an optical fiber or cable is connected to the incorrect port, then communication between the host devices 102 may be disrupted. Additionally or alternatively, if an optical fiber or cable breaks or becomes unintentionally disconnected, then communication between the host devices 102 may also be disrupted.

When these connection errors (e.g., connections to incorrect ports, optical fibers or cables breaking or disconnecting, etc.), it may be challenging to determine the cause or source of the connection errors due to the size and complexity of the optical cross connect 104. For example, it may be difficult to determine whether the optical fibers or cables in the optical cross connect 104 are all connected to the correct ports on the optical switches 106. As another example, it may be difficult to determine which optical fiber or cable is broken and needs replacing. As a result, the connection error may go unresolved, disrupting communications between the host devices 102.

The computer system 108 detects connection errors in the optical cross connect 104. For example, the computer system 108 may inject test signals into the optical ports in the optical switches 106. The optical switches 106 may carry these test signals through the optical cross connect 104 according to the connections of the optical fibers or cables in the optical cross connect 104. The computer system 108 may detect how the test signals travel through the optical cross connect 104 (e.g., by detecting optical power at the optical ports of the optical switches 106) to determine whether there are connection errors. For example, if the computer system 108 detects that the test signal did not travel between two optical ports in the optical cross connect 104, then the computer system 108 may determine that there is no optical connection between the two optical ports. If the computer system 108 detects that the test traveled successfully between two optical ports in the optical cross connect 104,

The computer system 108 uses a data structure 110 to track the state of connections in the optical cross connect 104. For example, the data structure 110 may indicate whether the connections between ports of the optical switches 106 in the optical cross connect 104 are valid or invalid. The computer system 108 updates the data structure 110 as the computer system 108 tests the connections in the optical cross connect 104. When a connection in the optical cross connect 104 is being used to communicate data between host devices 102, the computer system 108 may update the data structure 110 to indicate that the connection is locked so that the computer system 108 does not attempt to send test signals through the connection and disrupt communications between the host devices 102. In this manner, the computer system 108 detects and tracks connections errors in the optical cross connect 104. Additionally, the computer system 108 determines the causes or sources of connection errors, which allows the connection errors to be addressed and fixed, in certain embodiments.

FIG. 1B illustrates an example computer system 108 in the system 100 of FIG. 1A. As seen in FIG. 1B, the computer system 108 includes a processor 120 and a memory 122, which may perform the functions or features of the computer system 108 described herein. For example, the memory 122 stores the data structure 110 that tracks the states of connections in an optical cross connect. As another example, the processor 120 updates the data structure 110 as the computer system 108 tests optical connections in the optical cross connect.

The processor 120 is any electronic circuitry, including, but not limited to one or a combination of microprocessors, microcontrollers, application specific integrated circuits (ASIC), application specific instruction set processor (ASIP), and/or state machines, that communicatively couples to the memory 122 and controls the operation of the computer system 108. The processor 120 may be 8-bit, 16-bit, 32-bit, 64-bit or of any other suitable architecture. The processor 120 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 120 may include other hardware that operates software to control and process information. The processor 120 executes software stored on the memory 122 to perform any of the functions described herein. The processor 120 controls the operation and administration of the computer system 108 by processing information (e.g., information received from the optical cross connect and the memory 122). The processor 120 is not limited to a single processing device and may encompass multiple processing devices contained in the same device or computer or distributed across multiple devices or computers. The processor 120 is considered to perform a set of functions or actions if the multiple processing devices collectively perform the set of functions or actions, even if different processing devices perform different functions or actions in the set.

The memory 122 may store, either permanently or temporarily, data, operational software, or other information for the processor 120. The memory 122 may include any one or a combination of volatile or non-volatile local or remote devices suitable for storing information. For example, the memory 122 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 122, a disk, a CD, or a flash drive. In particular embodiments, the software may include an application executable by the processor 120 to perform one or more of the functions described herein. The memory 122 is not limited to a single memory and may encompass multiple memories contained in the same device or computer or distributed across multiple devices or computers. The memory 122 is considered to store a set of data, operational software, or information if the multiple memories collectively store the set of data, operational software, or information, even if different memories store different portions of the data, operational software, or information in the set.

FIG. 1C illustrates an example optical switch 106 in the system 100 of FIG. 1A. As discussed previously, the optical switch 106 may be part of an optical cross connect. As seen in FIG. 1C, the optical switch 106 includes multiple optical ports 130. Each of the optical ports 130 may serve as an input port or output port for optical signals. Optical fibers or cables may connect to the optical ports 130 to carry optical signals to the optical ports 130 or to carry optical signals away from the optical ports 130. The optical switch 106 may also establish internal connections between two optical ports 130. For example, the optical switch 106 may receive an optical signal at a first optical port 130 on the optical switch 106 (serving as an input port) and direct the optical signal to a second optical port 130 on the optical switch 106 (serving as an output port). In this manner, the optical switch 106 directs optical signals through the optical cross connect.

In some embodiments, the optical switch 106 includes sensors that detect optical power at the optical ports 130. The optical switch 106 may detect the optical power at the optical ports 130 and report the detected optical power to a computer system (e.g., the computer system 108 shown in FIG. 1A). The computer system may use the detected optical power to determine whether the optical ports 130 are handling optical signals.

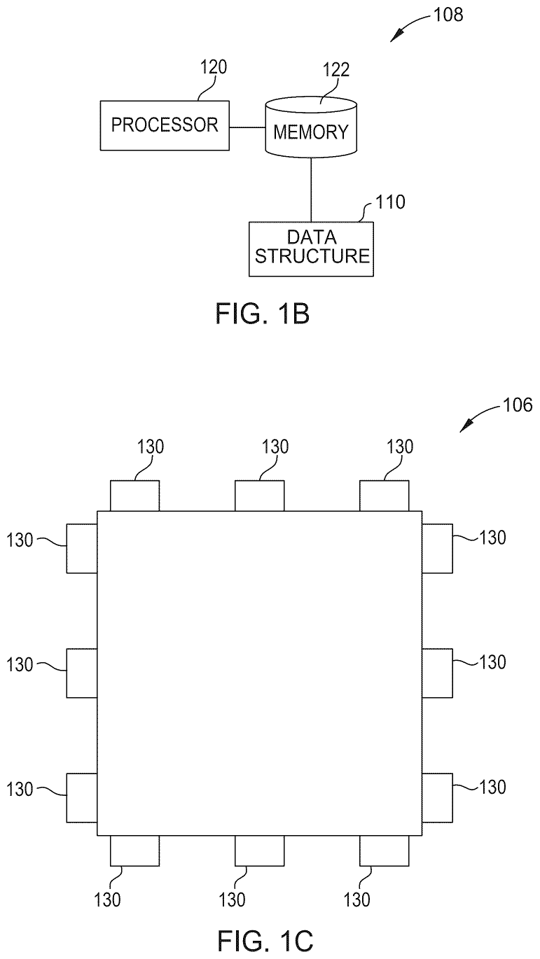

FIG. 2 illustrates an example data structure 110 in the system 100 of FIG. 1A. As discussed previously, a computer system (e.g., the computer system 108 shown in FIG. 1A) uses the data structure 110 to track the state of optical connections within an optical cross connect (e.g., the optical cross connect 104 shown in FIG. 1A). In the example of FIG. 2, the data structure 110 includes a column 202 that indicates output ports, a column 204 that indicates input ports, and a column 206 that indicates a state of the optical connection between the corresponding output port and input port.

The columns 202 and 204 designate an optical connection. The column 202 indicates an output port of the connection, and the column 204 indicates an input port of the connection. Each port may be indicated by a switch identifier that indicates the optical switch for the port and a port identifier that indicates the port on the optical switch. The data structure 110 may include a row for every possible optical connection in the optical cross connect. In the example of FIG. 2, the data structure 110 includes rows for the following optical connections: (i) the connection between switch 1, port 1 and switch 2, port 1, (ii) the connection between switch 1, port 1 and switch 2, port 2, (iii) the connection between switch 1, port 1 and switch 2, port 3, and (iv) the connection between switch 1, port 1 and switch 3, port 1.

The column 206 indicates the states of the optical connections. For example, the state “VALID” may indicate that an optical connection between two optical ports has been confirmed to be correct. The state “INVALID” may indicate that an optical connection between two ports is broken or nonexistent. In the example of FIG. 2, the column 206 indicates that (i) the connection between switch 1, port 1 and switch 2, port 1 is INVALID, (ii) the connection between switch 1, port 1 and switch 2, port 2 is VALID, (iii) the connection between switch 1, port 1 and switch 2, port 3 is INVALID, and (iv) the connection between switch 1, port 1 and switch 3, port 1 is INVALID.

As the computer system tests various optical connections, the computer system updates the column 206 in the data structure 110 to reflect updated states of the optical connections. For example, the computer system may detect that a broke fiber or cable between two optical ports has been replaced to re-establish an optical connection. In response, the computer system may update the state of that connection in the data structure 110 from INVALID to VALID. As another example, the computer system may detect that an optical connection has been broken. In response, the computer system may update the state of that connection in the data structure 110 from VALID to INVALID.

In some embodiments, the INVALID state in the column 206 may include other information that indicates a reason for the INVALID state. For example, the column 206 may further store an identifier or code that indicates a detected reason for the INVALID state. The identifier or code may indicate that the INVALID state is caused by no optical fiber or cable or a broken optical fiber or cable between two optical ports. The identifier or code may indicate that the INVALID state is caused by an incorrect type of fiber or cable being used between two optical ports.

In certain embodiments, the column 206 may indicate a LOCKED state for an optical connection. The LOCKED state indicates that the optical connection is being used to communicate a data signal (e.g., from one host device to another host device). As a result, the computer system will not test the optical connection to avoid disrupting the data signal. Instead, the computer system may limit testing to optical connections with INVALID and VALID states. When the optical connection stops communicating the data signal, the computer system may update the column 206 to indicate that the optical connection is VALID.

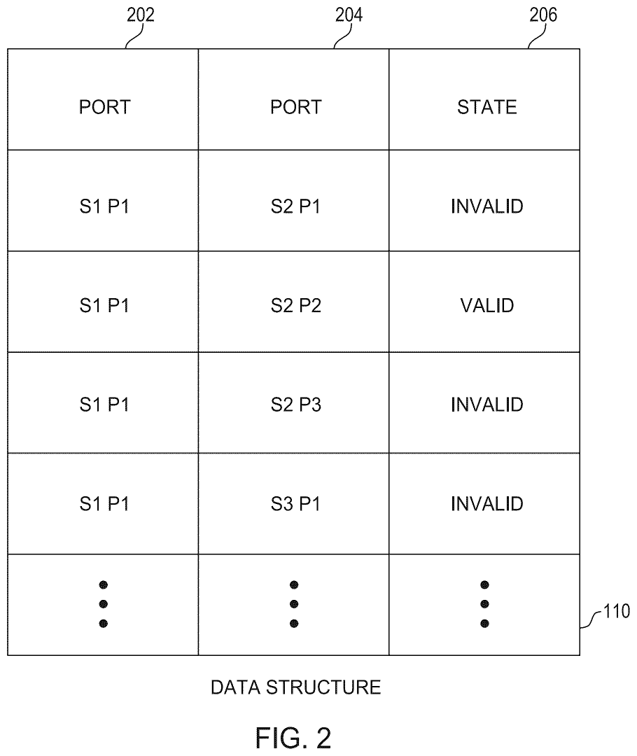

FIG. 3 illustrates an example operation 300 performed by the system 100 of FIG. 1A. A computer system (e.g., the computer system 108 shown in FIG. 1A) performs the operation 300. By performing the operation 300, the computer system tests an optical connection in an optical cross connect.

The computer system begins by injecting a test signal 302 into the optical cross connect. The computer system may use an optical source (e.g., a laser or a host device) to generate the test signal 302. The computer system then directs the test signal 302 from the optical source to the optical cross connect. In the example of FIG. 3, the computer system directs the test signal 302 to an optical port 130A on the optical switch 106A. The optical switch 106A directs the test signal 302 internally to the optical port 130B on the optical switch 106A. A cable or fiber may connect the optical port 130B to the optical port 130C on the optical switch 106B. As a result, the test signal 302 is communicated from the optical port 130B to the optical port 130C. The optical switch 106B directs the test signal 302 internally to the optical port 130D on the optical switch 106B.

The computer system may detect whether the test signal 302 is received at each optical port 130A, 130B, 130C, and 130D. For example, the computer system may detect or sense the optical power at each optical port 130A, 130B, 130C, and 130D to detect the test signal 302. If the proper optical power (e.g., the optical power of the test signal 302) is detected at each optical port 130A, 130B, 130C, and 130D, the computer system determines that the test signal 302 reached each optical port 130A, 130B, 130C, and 130D.

The computer system then updates the data structure 110 to reflect that the test signal 302 reached each optical port 130A, 130B, 130C, and 130D. For example, the computer system may update the row of the data structure 110 for the optical connection between the optical port 130A and the optical port 130D to indicate the VALID state. The computer system may also update the rows of the data structure 110 for the optical connection between the optical port 130A and the optical port 130B, the optical connection between the optical port 130B and the optical port 130C, and the optical connection between the optical port 130C and the optical port 130D to indicate that these optical connections are VALID.

The computer system may continue testing the optical connection to determine that the optical connection remains VALID. For example, the computer system may continue sending test signals to the optical port 130A and determining whether the test signals are received at the optical ports 130B, 130C, and 130D. If the test signals are received at the optical ports 130A, 130B, 130C, and 130D, the computer system may maintain the VALID state for these optical connections in the data structure 110.

In some embodiments, the computer system may also modulate the test signal 302 with data. The computer system may direct the test signal 302 received at the optical port 130D to a receiver that extracts the data from the test signal 302. The computer system then analyzes the data to determine whether the data was correctly received at the receiver. If the data was correctly received, then the computer system verifies that the optical connections are VALID. If the data was not received correctly (e.g., the received data does not match the data used to modulate the test signal 302), then the computer system may indicate that the optical connection is faulty using the INVALID state. In this manner, the computer system implements an additional check to determine the state of the optical connection.

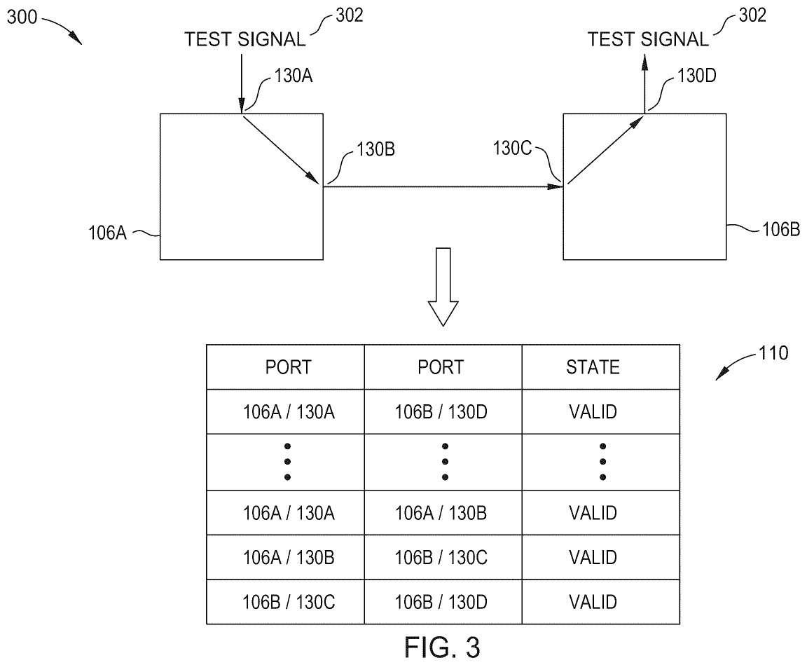

FIG. 4 illustrates an example operation 400 performed by the system 100 of FIG. 1A. A computer system (e.g., the computer system 108 shown in FIG. 1A) performs the operation 400. By performing the operation 400, the computer system locks an optical connection from testing.

The computer system begins by detecting that a data signal 402 is being communicated to the optical cross connect. The data signal 402 may be communicated by a host device to another host device through the optical cross connect. The computer system detects the optical switches and ports used to communicate the data signal 402. In the example of FIG. 4, the computer system may detect that the data signal 402 is communicated through the optical ports 130A, 130B, 130C, and 130D. In response, the computer system updates the data structure 110 to indicate that the optical connection between the optical ports 130A and 130D is LOCKED. The computer system also updates the data structure to indicate that the optical connection between the optical port 130A and the optical port 130B, the optical connection between the optical port 130B and the optical port 130C, and the optical connection between the optical port 130C and the optical port 130D are LOCKED. When these optical connections are LOCKED, the computer system will refrain from testing these optical connections. For example, the computer system may refrain from communicating test signals to these optical connections to avoid disrupting the data signal 402. When the computer system determines that the host devices have completed communicating the data signal 402, the computer system unlocks these optical connections and indicates in the data structure 110 that the optical connections are VALID. The computer system may then test these optical connections.

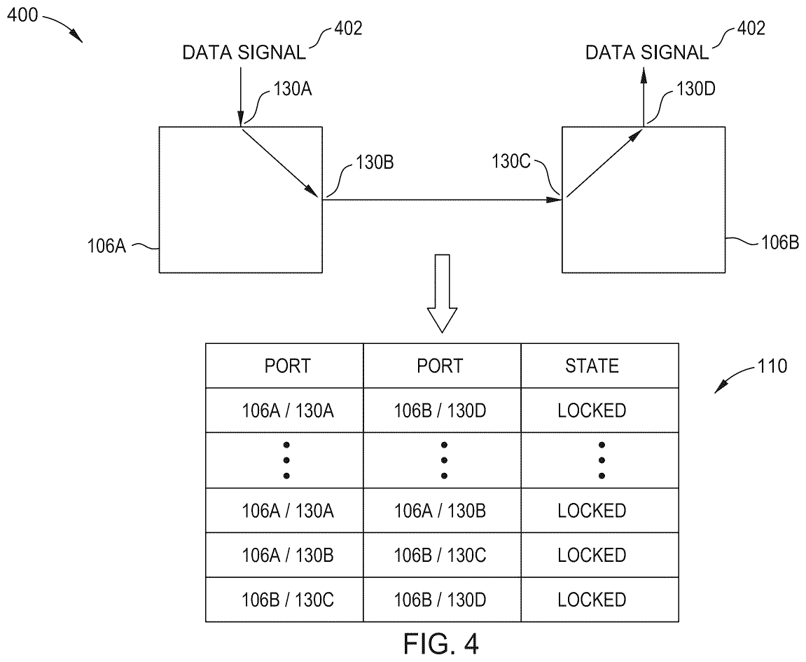

FIG. 5 illustrates an example operation 500 performed by the system 100 of FIG. 1A. A computer system (e.g., the computer system 108 shown in FIG. 1A) performs the operation 500. By performing the operation 500, the computer system determines that an optical connection is INVALID.

The computer system begins by communicating a test signal 502 (e.g., from an optical source) to the optical cross connect. In the example of FIG. 5, the test signal 502 is communicated to the optical port 130A. The optical switch 106A directs the test signal 502 internally to the optical port 130B. The connection between the optical ports 130B and 130C may be broken. For example, the cable or fiber connecting the optical ports 130B and 130C may have failed or broken. As another example, the cable or fiber connecting the optical ports 130B and 130C may have been removed. As another example, the cable or fiber connecting the optical ports 130B and 130C may have been moved erroneously (e.g., to connect the optical port 130B to another optical port other than optical port 130C).

The computer system detects that the test signal 502 is received at the optical ports 130A and 130B but not the optical ports 130C and 130D. In response, the computer system determines that certain portions of the optical connection between the optical port 130A and 130D are broken. The computer system updates the data structure 110 to show that the optical connection between the optical ports 130A and 130D is INVALID. The computer system also updates the data structure 110 to indicate that the optical connection between the optical port 130A and the optical port 130B is VALID, that the optical connection between the optical port 130B and the optical port 130C is INVALID, and that the optical connection between the optical port 130C and the optical port 130D is INVALID. As a result, the data structure 110 indicates the optical connections in the optical cross connect that the computer system could not validate.

In some embodiments, the computer system further updates the data structure 110 to indicate a cause for an optical connection being INVALID. For example, the computer system may include an identifier or code with the INVALID state to indicate a cause. The identifier or code may indicate any cause detected by the computer system. For example, the identifier or code may indicate that the optical fiber or cable failed or broke, that the optical fiber or cable was removed, and/or that the optical fiber or cable was moved or connected to the wrong port(s). In this manner, the data structure 110 may further suggest a fix for the optical connection.

The computer system may continue testing these optical connections to determine whether the optical connections are repaired. For example, if the optical fiber or cable between the optical ports 130B and 130C is replaced, the computer system may detect the test signal 502 at the optical ports 130C and 130D. In response, the computer system may update the data structure 110 to indicate that the optical connection between the optical ports 130A and 130D, the optical connection between the ports 130B and 130C, and the optical connection between the optical ports 130C and 130D are VALID.

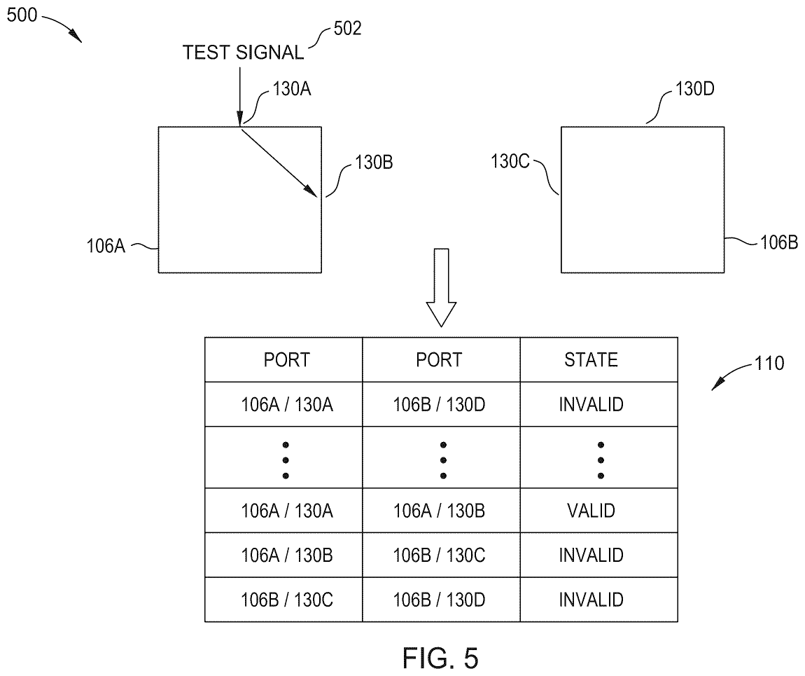

FIG. 6 illustrates an example operation 600 performed by the system 100 of FIG. 1A. A computer system (e.g., the computer 108 shown in FIG. 1A) performs the operation 600. By performing the operation 600, the computer system tests the topology of an optical cross connect.

The computer system begins by directing a test signal 602 (e.g., from an optical source) to the optical port 130A. The computer system may detect that the test signal 602 is directed through the optical ports 130B and 130C to the optical port 130D. In some instances, even though the test signal 602 was directed to the optical port 130D, the test signal 602 may not have travelled through the proper optical ports (e.g., indicating that an optical fiber or cable is connected to the wrong optical port(s)).

The computer system compares the path taken by the test signal 602 to a topology 604. The topology 604 may be a connection topology or wiring plan provided by an administrator or designer of the optical cross connect. The topology 604 may indicate which optical fibers or cables should be used in the optical cross connect and to which ports these optical fibers or cables should be connected. Using the topology 604, the computer system may determine whether the test signal 602 took an incorrect path through the optical cross connect.

In the example of FIG. 6, the computer system determines, from the topology 604, that the test signal 602 took an incorrect path through the optical cross connect. For example, the topology may indicate that the optical port 130B should be connected to an optical port other than the optical port 130C. As a result, the test signal 602 was erroneously communicated to the optical port 130C. In response, the computer system updates the data structure 110 to indicate that the optical connection between the optical port 130A and 130D is INVALID. Although the optical connection is not broken, the optical connection takes the incorrect path through the optical cross connect. The computer system may include an identifier or code in the data structure 110 to indicate that the cause of the INVALID state is an incorrect connection.

If the optical fiber or cable between the optical ports 130B and 130C is moved so that the optical fiber or cable is connected properly according to the topology 604, the computer system may detect that the test signal 602 is being communicated to the proper optical ports, and the computer system may update the data structure 110 to indicate that the optical connection between the ports 130A and 130D is VALID.

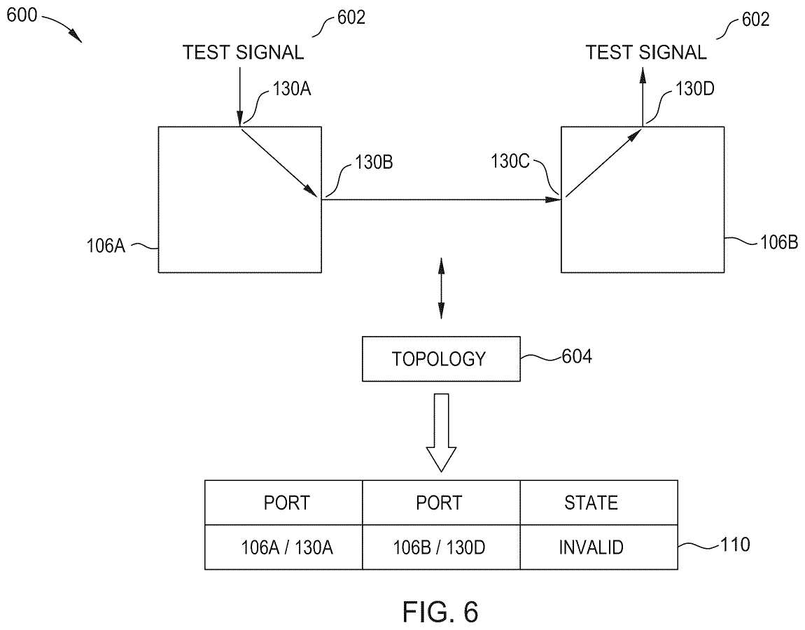

FIG. 7 illustrates an example operation 700 performed by the system 100 of FIG. 1A. A computer system (e.g., the computer 108 shown in FIG. 1A) performs the operation 700. By performing the operation 700, the computer system tests a connection to access the optical cross connect.

As seen in FIG. 7, the optical switch 106 includes a loopback cross-connect in which the optical switch 106 connects the optical port 130 to itself. As a result, an optical signal communicated to the optical port 130 is also received at the optical port 130. The computer system may direct an optical signal (e.g., a test signal) from the host device 102 to the optical port 130 to test whether the host device 102 may access the optical cross connect. If the computer system detects the optical signal at the optical port 130, then the computer system determines that the host device 102 has access to the optical cross connect. The computer system may update the data structure to indicate that an optical connection between the host device 102 and the optical port 130 is VALID.

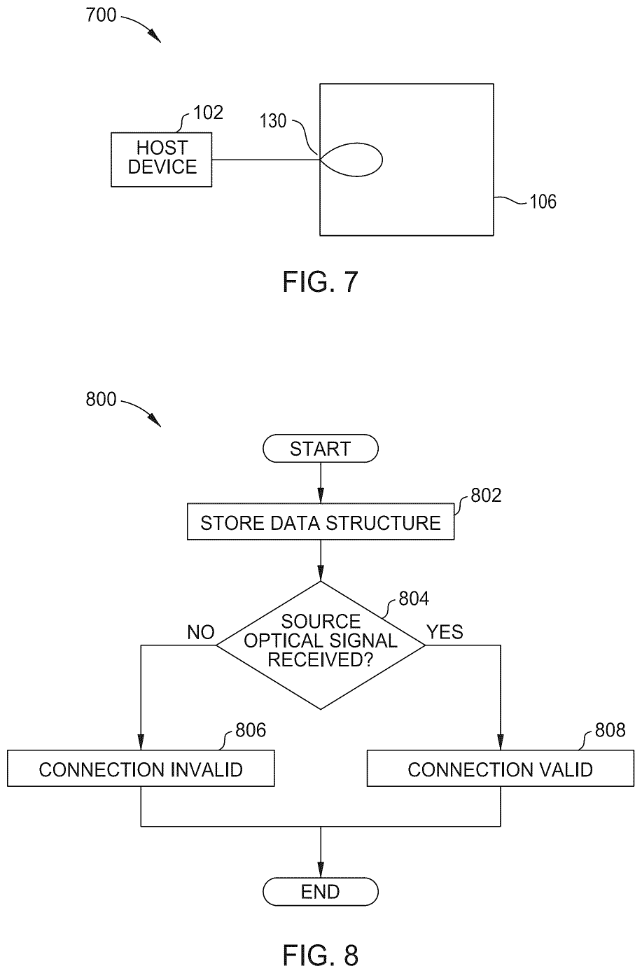

FIG. 8 is a flowchart of an example method 800 performed by the system 100 of FIG. 1A. In particular embodiments, a computer system (e.g., the computer system 108 shown in FIG. 1A) performs the method 800. By performing the method 800, the computer system discovers the topology of an optical cross connect and validates optical connections in the optical cross connect.

In block 802, the computer system stores a data structure (e.g., the data structure 110 shown in FIG. 1A). The data structure indicates the states of the optical connections in the optical cross connect. For example, the data structure may indicate whether the optical connections between the optical ports in the optical cross connect are VALID or INVALID. The computer system updates the data structure as the computer system tests the optical connections.

In block 804, the computer system determines whether a source optical signal (e.g., a test signal) was received at optical ports in the optical cross connect. For example, the computer system may direct the source optical signal from an optical source to the optical cross connect. The optical cross connect may then direct the source optical signal through optical ports in the optical cross connect to a destination (e.g., an optical port in the optical cross connect, a host device, or a receiver). The computer system may determine whether the source optical signal was received at one or more of the optical ports in the optical path. For example, the computer system may detect the optical power at these optical ports to detect whether the source optical signal was received at these optical ports.

If the source optical signal was not received at these optical ports, the computer system determines that the optical connection is INVALID in block 806. The computer system may update a data structure to indicate that the optical connection is INVALID. If the source optical signal was received at these optical ports, the computer system determines that the optical connection is VALID in block 808. The computer system may update the data structure to indicate that the optical connection is VALID. In this manner, the data structure indicates the states of optical connections in the optical cross connect.

In summary, the computer system 108 discovers the topology of an optical cross connect 104. For example, the computer system 108 may inject optical test signals into the optical cross connect 104 and detect how the test signal travels through the optical cross connect 104. The computer system 108 may detect whether the test signal was communicated to the correct ports in the optical cross connect 104 to validate the connections in the optical cross connect 104.

The computer system 108 uses a data structure 110 to track the states of optical connections in the optical cross connect 104. The computer system 108 updates the data structure 110 when the computer system 108 validates a connection or when the computer system 108 detects an error in a connection. The data structure 110 thus reflects the state of the interconnects in the optical cross connect 104. When connection errors are corrected (e.g., by replacing optical fibers or re-connecting optical fibers), the computer system 108 detects the correction and updates the data structure 110 accordingly.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product.

Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer system comprising:
one or more memories configured to store a data structure indicating a state of a connection between a first optical port of a first optical switch of an optical cross connect and a second optical port of a second optical switch of the optical cross connect different from the first optical switch; and
one or more processors communicatively coupled to the one or more memories, a combination of the one or more processors configured to:
determine that a source optical signal communicated to the first optical port is received at the second optical port over the connection; and
update the data structure such that the state indicates that the connection is valid.

2. The computer system of claim 1, wherein the combination of the one or more processors is further configured to maintain the state in the data structure in response to determining that the source optical signal is received at the second optical port over the connection after updating the data structure such that the state indicates that the connection is valid.

3. The computer system of claim 1, wherein the combination of the one or more processors is further configured to update the data structure such that the state indicates that the connection is locked based on an optical signal different from the source optical signal being communicated over the connection.

4. The computer system of claim 1, wherein the combination of the one or more processors is further configured to update the data structure such that the state indicates that the connection is invalid in response to determining that the second optical port stops receiving the source optical signal over the connection.

5. The computer system of claim 4, wherein the combination of the one or more processors is further configured to, after updating the data structure such that the state indicates that the connection is invalid, update the data structure such that the state indicates that the connection is valid in response to determining that the second optical port begins receiving the source optical signal over the connection.

6. The computer system of claim 1, wherein the combination of the one or more processors is further configured to determine an optical power at the second optical port, and wherein determining that the source optical signal is received at the second optical port is based on the optical power.

7. The computer system of claim 1, wherein the source optical signal is modulated with data and wherein determining that the source optical signal is received at the second optical port comprises determining that a receiver communicatively coupled to the second optical port extracted, from the source optical signal, the data.

8. The computer system of claim 1, wherein the combination of the one or more processors is further configured to determine that the data structure should be updated such that the state indicates that the connection is valid based on a connection topology comprising the first optical switch and the second optical switch.

9. The computer system of claim 1, wherein:
the first optical switch further comprises a third optical port;
the source optical signal is communicated to the third optical port;
the combination of the one or more processors is further configured to:
determine that the source optical signal was communicated from the third optical port to the first optical port through an internal connection of the first optical switch; and
update the data structure such that the data structures indicates a state of the internal connection is valid.

10. A method comprising:
storing a data structure indicating a state of a connection between a first optical port of a first optical switch of an optical cross connect and a second optical port of a second optical switch of the optical cross connect different from the first optical switch;
determining that a source optical signal communicated to the first optical port is received at the second optical port over the connection; and
updating the data structure such that the state indicates that the connection is valid.

11. The method of claim 10, further comprising maintaining the state in the data structure in response to determining that the source optical signal is received at the second optical port over the connection after updating the data structure such that the state indicates that the connection is valid.

12. The method of claim 10, further comprising updating the data structure such that the state indicates that the connection is locked based on an optical signal different from the source optical signal being communicated over the connection.

13. The method of claim 10, further comprising updating the data structure such that the state indicates that the connection is invalid in response to determining that the second optical port stops receiving the source optical signal over the connection.

14. The method of claim 13, further comprising, after updating the data structure such that the state indicates that the connection is invalid, updating the data structure such that the state indicates that the connection is valid in response to determining that the second optical port begins receiving the source optical signal over the connection.

15. The method of claim 10, further comprising determining an optical power at the second optical port, and wherein determining that the source optical signal is received at the second optical port is based on the optical power.

16. The method of claim 10, wherein the source optical signal is modulated with data and wherein determining that the source optical signal is received at the second optical port comprises determining that a receiver communicatively coupled to the second optical port extracted, from the source optical signal, the data.

17. The method of claim 10, further comprising determining that the data structure should be updated such that the state indicates that the connection is valid based on a connection topology comprising the first optical switch and the second optical switch.

18. A non-transitory computer readable medium storing instructions that, when executed by a combination of one or more processors, cause the combination of one or more processors to:
store a data structure indicating a state of a connection between a first optical port of a first optical switch of an optical cross connect and a second optical port of a second optical switch of the optical cross connect different from the first optical switch;
determine that a source optical signal communicated to the first optical port is received at the second optical port over the connection; and
update the data structure such that the state indicates that the connection is valid.

19. The medium of claim 18, wherein the instructions further cause the combination of one or more processors to maintain the state in the data structure in response to determining that the source optical signal is received at the second optical port over the connection after updating the data structure such that the state indicates that the connection is valid.

20. The medium of claim 18, wherein the instructions further cause the combination of one or more processors to update the data structure such that the state indicates that the connection is locked based on an optical signal different from the source optical signal being communicated over the connection.
